(19) United States
(12) Patent Application Publication
(10) Pub. No.: US 2009/0046006 A1
(43) Pub. Date: Feb. 19, 2009

(54) DIRECTIONAL COMMUNICATION APPARATUS, COMMUNICATION METHOD, COMMUNICATION PROGRAM, AND COMMUNICATION SYSTEM USING DIRECTIONAL COMMUNICATION APPARATUS

(75) Inventor: Katsutoshi Inagaki, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Meguro-ku, Tokyo (JP)

(21) Appl. No.: 11/909,690

(22) PCT Filed: Mar. 7, 2006
(86) PCT No.: PCT/JP2006/304384

§ 371 Date: Sep. 25, 2007

(30) Foreign Application Priority Data
Mar. 25, 2005 (JP) 2005-088946

(51) Int. Cl. H04B 7/10; H01Q 3/00

(52) U.S. Cl. 342/372

(57) ABSTRACT

There are provided a directional communication apparatus whose low power consumption is realized, a communication system using this apparatus, a directional communication apparatus where time up to establishment of communication after restart of the communication is shortened, and a communication system using this apparatus.

The directional communication apparatus has an antenna capable of controlling a directional characteristic, an information storage section which stores communication history for specifying communication conditions at the time of communication, and a control section which controls the antenna based on the communication history so that the antenna can communicate with a destination device recorded in the communication history. The directional communication apparatus calculates a movement vector based on the communication history, estimates a moved position of the destination device, and estimates communication conditions optimum for communication so as to restart the communication.

### TECHNICAL FIELD

The present application relates to a directional communication apparatus, a communication method, a communication program, and a communication system using the directional communication apparatus.

### BACKGROUND ART

Conventionally, various techniques relating to radio transmission/output apparatus suitable for low power consumption have been introduced (for example, see Patent Document 1).

Patent Document 1: Japanese Patent Application Laid-Open No. 2000-299659

### DISCLOSURE OF THE INVENTION

### Problem to be Solved by the Invention

The above conventional technique sets a directional pattern to a low directional characteristic until a communication link with another radio station is established, sets the directional pattern to a high directional characteristic after the communication link is established so as to reduce a transmission output to achieve lower power consumption in a radio transmission/output control apparatus capable of controlling the directional characteristic.

An operation at this time is described with reference to a flow chart shown in FIG. 1. At the beginning of the communication, a transmission apparatus transmits a radio wave with low directional characteristic and a strong transmission power so as to search for a reception apparatus (S1). After the receiving apparatus is found and the communication is established (Y at S2), the directional characteristic is changed into a high directional pattern (S3), and a process (S4) of reducing (adjusting) a transmission power is executed until the communication state becomes stable (S5), so that the entire power consumption is reduced.

In the conventional technique, however, in the case where after the once established communication with a party is cut off, the communication is again started, the communication is started with directional characteristic being low and the transmission power being strong. For this reason, it takes a time that the communication state becomes stable, and useless power is consumed.

After the communication is restarted, it takes a time to make the communication state stable, and thus under the condition that the reception apparatus gets away, if the communication is carried out with the high directional pattern just after the communication is restarted, the communication can be established. However, since the communication is started with low directional characteristic at the time of restarting the communication, the receiver cannot be found and thus the communication cannot takes place.

The present application is devised in view of the above problems, and its object is to provide a directional communication apparatus which realizes a low power consumption, a communication system using this apparatus, a directional communication apparatus which shortens the time up to the establishment of communication after starting of the communication, and a communication system using this apparatus.

### Means for Solving the Problem

The present application is described below. In order to make the understanding of the present application easy, reference symbols of attached drawings are put in parentheses, but the present application is not limited to embodiments in the drawings by this.

In order to solve the above problem, from a viewpoint of the present application, a directional communication apparatus (1, 2) is characterized by comprising:

a directional antenna (11, 21) capable of controlling a directional characteristic;

storage means (16, 26) for storing communication history including communication conditions at the time of communication; and

control means (17, 27) for controlling the directional antenna based on the stored communication history so that the antenna can communicate with a destination device recorded in the communication history.

In order to solve the above problem, from another viewpoint of the present application, a communication method of a communication apparatus (1, 2) having a directional antenna (11, 21) capable of controlling a directional characteristic is characterized by comprising:

a step for storing communication history including communication conditions at the time of communication; and

a step for controlling the directional antenna based on the stored communication history so that the directional antenna can communicate with a destination device recorded in the communication history.

In order to solve the above problem, from another viewpoint of the present application, a communication program is characterized by allowing a computer included in a communication apparatus (1, 2) having a directional antenna (11, 21) capable of controlling a directional characteristic to operate as:

storage means for storing communication history including communication conditions at the time of communication; and

control means for controlling the directional antenna based on the stored communication history so that the directional antenna can communicate with a destination device recorded in the communication history.

In order to solve the above problem, from another viewpoint of the present application, a communication system, using the directional communication apparatus, is characterized in that communication is carried out with any one of the directional communication apparatuses being used as a transmission apparatus, and the other one being used as a reception apparatus.

In order to solve the above problem, from another viewpoint of the present application, the directional communication apparatus and a plurality of base stations which communicate with the directional communication apparatus are provided.

### BRIEF DESCRIPTION OF THE DRAWINGS

FIG. 1 is a flow chart illustrating an operation of a conventional technique;

FIG. 2 is a block diagram illustrating an outline of an entire constitution of a transmission/reception system according to one embodiment;

FIG. 3 is a flow chart when the communication of high-directional control is viewed from the side of a transmission/reception apparatus serving as a transmission apparatus according to one embodiment;

FIG. 4 is a flow chart when the communication of the high-directional control is viewed from the side of the transmission/reception apparatus serving as a reception apparatus according to one embodiment;

FIG. 5 is a diagram illustrating an outline of the constitution of the communication system according to a second embodiment;

FIG. 6 is a flow chart when the communication is viewed from the side of the transmission/reception apparatus serving as the transmission apparatus according to the second embodiment;

FIG. 7 is a diagram for explaining the process of estimating a transfer destination of a destination device using a movement vector; and

FIG. 8 is a diagram for explaining another process of estimating a transfer destination of a destination device using a movement vector.

### DESCRIPTION OF LETTERS OR NUMERALS

1: transmission/reception apparatus serving as a transmission apparatus
2: transmission/reception apparatus serving as a reception apparatus
11, 21: antenna
12, 22: transmission/reception common section
13, 23: transmission circuit
14, 24: reception circuit
15, 25: modulation/demodulation section
16, 26: information storage section
17, 27: control section
18, 28: input/output terminal
19, 29: time counting section

### BEST MODE FOR CARRYING OUT THE INVENTION

A best mode of the present application is described below with reference to the drawings.

### First Embodiment

The first embodiment describes a basic embodiment in the case where a transmission apparatus and a reception apparatus have the same constitution, and communication is restarted under a condition that a relative position of the transmission apparatus and the reception apparatus does not change.

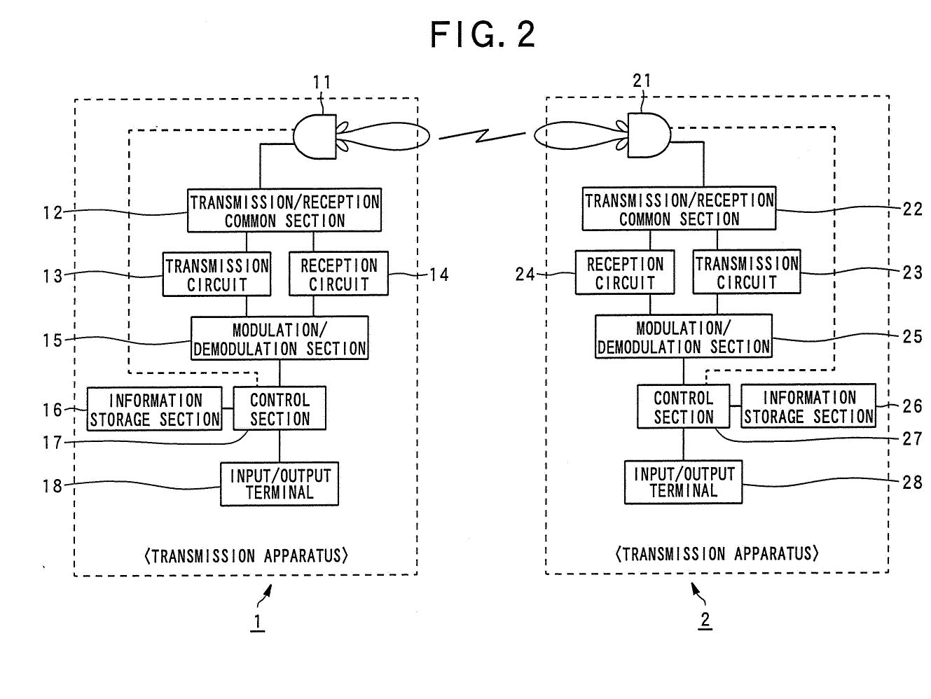

FIG. 2 is a block diagram illustrating an outline of an entire constitution of a transmission/reception system according to one embodiment.

When bidirectional communication is carried out between a pair of transmission/reception apparatuses, one transmission/reception apparatus serves as the transmission apparatus and the other transmission/reception apparatus serves as the reception apparatus at a certain moment. In the following description with reference to FIG. 2, the communication is restarted under a condition that the left-side transmission/reception apparatus serves as the transmission apparatus and the right-side transmission/reception apparatus serves as the reception apparatus.

The transmission/reception apparatus which serves as the transmission apparatus 1 and the transmission/reception apparatus which serves as the reception apparatus 2 are composed of antennas 11 and 21 which can control directional characteristic, transmission/reception common sections 12 and 22 having a function for switching between transmission and reception, transmission circuits 13 and 23, reception circuits 14 and 24, modulation/demodulation sections 15 and 25, control sections 17 and 27, information storage sections 16 and 26, and the input/output terminals 18 and 28, respectively.

The antennas 11 and 21 are general directional antennas which enables reception of a radio wave and transmission of a radio wave, namely, bidirectional communication. Communication conditions (communication direction, communication range and transmission power) are controlled based on instructions from the control sections 17 and 27, mentioned later.

The transmission/reception common sections 12 and 22 transmit transmission signals from the transmission circuits 13 and 23, mentioned later, to the antennas 11 and 21, and switch the reception signals received by the antennas 11 and 21 so as to transmit the these signals to the reception circuits 14 and 24.

The transmission circuits 13 and 23 transmit signals sent from the modulation/demodulation sections 15 and 25, mentioned later, as transmission signals to the transmission/reception common sections 12 and 22.

The reception circuits 14 and 24 acquire the radio waves received by the antennas 11 and 21 as reception signals so as to transmit them to the modulation/demodulation sections 15 and 25, mentioned later.

The modulation/demodulation sections 15 and 25 have a modulation circuit and a demodulation circuit, modulate signals acquired from the control sections 17 and 27, mentioned later, so that the signals are suitable for a process in the transmission circuits 13 and 23, and demodulate the signals acquired from the reception circuits 14 and 24 so that the signals are suitable for a process in the control sections.

The control sections 17 and 27 are composed of a CPU (Central Processing Unit) and its peripheral circuit, control the functions of the respective components of the transmission/reception apparatus, and process a communication signal. Further, the control sections 17 and 27 control communication conditions of the antennas 11 and 21.

The information storage sections 16 and 26 are composed of a flash memory, a RAM (Random Access Memory) or a hard disc drive, and store communication history therein. The information storage sections 16 and 26 output the stored communication history to the control sections 17 and 27 according to requests from the control sections 17 and 27. The communication history to be stored includes device information such as an IP (Internet Protocol) address and a MAC (Media Access Control) address for specifying the reception apparatus 2, and communication condition parameters including electric power saving set parameters such as directional parameters having a transmission direction (direction of the reception apparatus 2), transmission/output setting at the time of transmission and a reactance value at the time of transmission.

The input/output terminals 18 an 28 are composed of an input/output device including a microphone and a speaker, and capture sound information with which a user desires to communicate into the transmission/reception apparatus.

The pair of transmission/reception apparatuses having the above constitution carry out the bidirectional communication.

The antennas 11 and 21 in this embodiment compose a directional antenna of the present application, the control sections 17 and 27 compose a control device of the present application, the transmission/reception apparatus which serves as the transmission apparatus 1 composes a transmission apparatus of the present application, the transmission/reception apparatus which serves as the reception apparatus 2 composes a reception apparatus of the present application, and the information storage sections 16 and 26 compose a storage device of the present application.

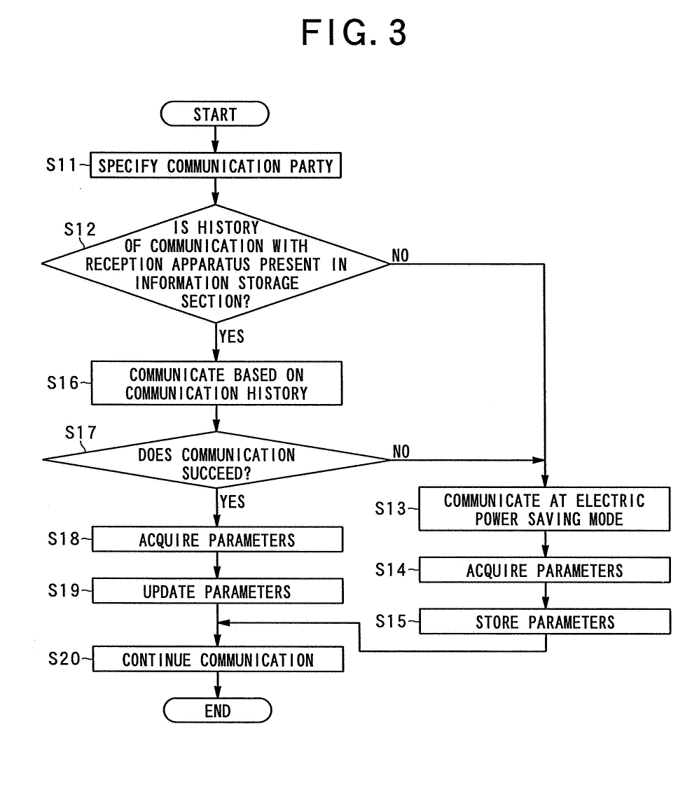

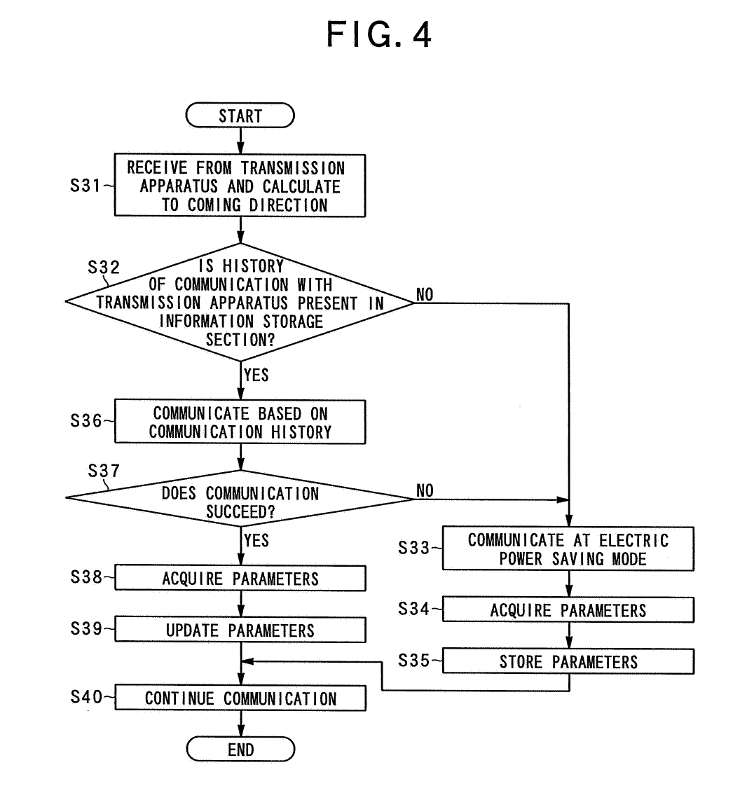

The case where a pair of the transmission/reception apparatuses having the above constitution carries out high-directional communication of the present application is described below with reference to the flow charts in FIGS. 3 and 4.

FIG. 3 is a flow chart when the communication of high-directional control is viewed from the side of the transmission/reception apparatus serving as the transmission apparatus 1 according to one embodiment. FIG. 4 is a flow chart when the communication is viewed from the side of the transmission/reception apparatus serving as the reception apparatus 2.

In FIG. 3, when the power of the transmission apparatus is turned on, information for specifying a destination device as a communication object (reception apparatus 2) is input and starting of the communication is instructed (S11), the control section 17 checks whether communication history between the information storage section 16 and the reception apparatus 2 is present (S12).

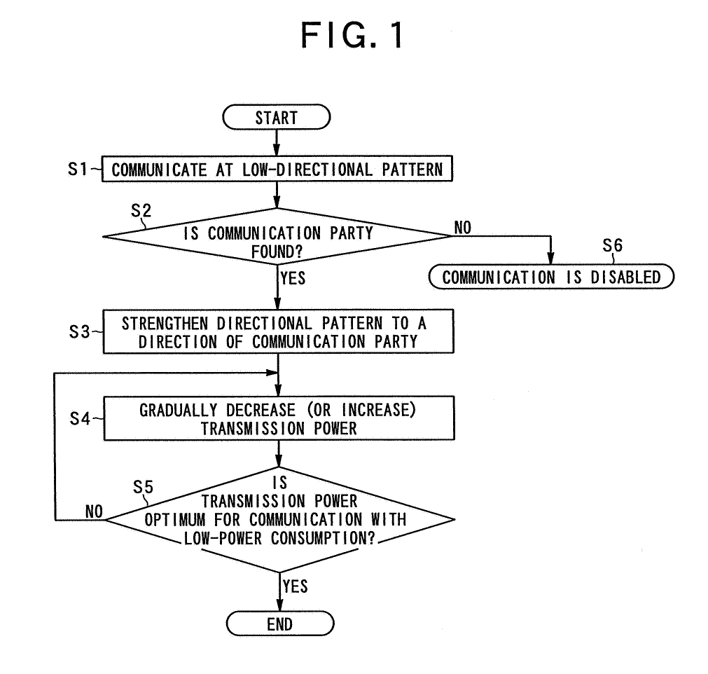

When the communication history of the reception apparatus 2 is not present (Nat S12), since this means that the communication with the reception apparatus 2 is not carried out, the communication with the reception apparatus 2 is started at a low-directional pattern by the method similar to the conventional technique. The directional characteristic is improved after the communication is established, and the transmission power is reduced so that the communication transfers to an electric power saving mode (S13) (the operation similar to S1 to S5 in the flowchart shown in FIG. 1). After the communication is stable, communication condition parameters at that time are acquired (S14) and are stored as communication history into the information storage section 16 (S15), so that the communication continues (S20).

As shown in FIG. 4, the reception apparatus 2 receives the signals from the transmission apparatus 1 (see S16 and S13 in FIG. 3) so as to calculate an electric wave coming direction (S31).

A search is conducted whether the communication history relating to the transmission apparatus 1 is present in the information storage section 26 of the reception apparatus 2 (S32).

When the communication history relating to the transmission apparatus 1 is not present in the information storage section 26 (N at S32), after the communication in the electric power saving mode optimum for the communication is established by the method similar to the conventional technique (S33), the communication condition parameters for the transmission apparatus 1 are acquired (S34) and stored in the information storage section 26 (S35) so that the communication continues (S40).

Since the reception apparatus 2 receives a radio wave from the transmission apparatus 1 so that the communication is started, a process of searching the transmission apparatus 1 at the low-directional pattern (S1 in the flowchart shown in FIG. 1) is not necessary.

On the other hand, when the communication history relating to the transmission apparatus 1 is present in the information storage section 26 of the reception apparatus 2 (Y at S32), the communication is carried out based on the communication condition parameters in the communication history in the coming direction of the radio wave from the transmission apparatus 1 (S36). When the communication succeeds (Y at S37), communication condition parameters for the transmission apparatus 1 are acquired (S38), and the communication condition parameters stored in the information storage section 26 are updated (S39) so that the communication continues (S40). As a result, the communication with the transmission apparatus 1 can be carried out.

When the communication based on the communication condition parameters in the communication history does not succeed (N at S37), this is similar to the case where the history of communication with the reception apparatus is not present in the communication history (N at S33), and thus the sequence goes to process after step S33 so that the communication continues (S40).

With reference to FIG. 3, when the history of the communication with the reception apparatus 2 as a communication object is present in the information storage section 16 of the transmission apparatus 1 (Y at S12), the communication is carried out based on the communication condition parameters in the communication history (S16). When the communication succeeds (Y at S17), the communication condition parameters are acquired (S18), and the communication history in the information storage section 16 of the transmission apparatus 1 is updated (S19) so that the communication continues (S20).

When the communication based on the communication condition parameters in the communication history does not succeed (N at S17), this is similar to the case where the history of the communication with the reception apparatus 2 is not present in the communication history (N at S12). For this reason, the sequence goes to the process after step S13, and the communication with the reception apparatus 2 is started at a low-directional pattern (S13). After the communication condition parameters are acquired (S14), they are stored in the information storage section 16 of the transmission apparatus 1 (S15) so that the communication continues (S20).

The first embodiment produces the following effect.

The transmission apparatus 1 and the reception apparatus 2 include the antennas 11 and 21 which can control the directional characteristic, the information storage sections 16 and 26 which store the communication history including the communication conditions at the time of communication, and the control sections 17 and 27 which control the antennas 11 and 21 so that the antennas 11 and 21 can communicate with the destination device recorded in the communication history based on the stored communication history, respectively. For this reason, the antennas 11 and 21 are controlled based on the communication history so as to have high-directional characteristic and weak communication power, and the communication with the destination device can be restarted. As a result, the low power consumption and the shortening of the time from the starting of the communication to the establishment of the communication can be realized.

Since the transmission apparatus 1 restarts the communication with the reception apparatus 2 under the same communication condition as those in the previous communication stored in the information storage section 16, the communication can be restarted early.

Since the communication can be restarted with high-directional characteristic and weak transmission power at the beginning of the restart of the communication based on the communication condition parameters in the communication history, the power consumption at the time of the restart of the communication can be reduced.

Since the communication conditions at the time of the restart can be determined based on the communication history, the time for searching for the reception apparatus 2 and the time for checking the communication conditions optimum for the communication can be omitted, and thus the communication can be started just after the power is again turned on.

In the first embodiment of the present application, when the processes at steps S15 and 19 are executed, a “recording device” in claims is realized, and when the process at step S16 is executed, a “control device” in claims is realized.

The embodiment of the present application is not limited to the above embodiment, and thus it may be modified as follows.

The first embodiment describes that the transmission/reception apparatus on the side of the transmission apparatus and the transmission/reception apparatus on the side of the reception apparatus have the same constitution, but the constitution is not limited to this, and thus the reception apparatus may be an omnidirectional communication apparatus without directional characteristic. Like the case of the communication between a mobile phone terminal and a plurality of base stations, the present application can be applied even to a communication system having a relationship between the transmission/reception apparatus (mobile terminal) which can control the directional characteristic and a telephone base station as one example of a base station. In this case, the communication can be restarted with a high-directional characteristic and a weak communication power based on the communication history, the low power consumption can be realized, and the time up to the establishment of the communication after the restart of the communication can be shortened.

Programs corresponding to the flow charts shown in FIGS. 3 and 4 are recorded in an information recording medium such as a flexible disc or a hard disc, or the programs are delivered via a network such as an internet so as to be recorded. The programs are read and executed by universal microcomputers provided to the control section 17 of the transmission/reception apparatus serving as the transmission apparatus 1 and the control section 27 of the transmission/reception apparatus serving as the reception apparatus 2, so that the microcomputers can be served as the control sections 17 and 27.

### Second Embodiment

The second embodiment is an example that the present application is applied to the case where the communication is restarted under the condition where a relative position between the transmission apparatus and the reception apparatus changes.

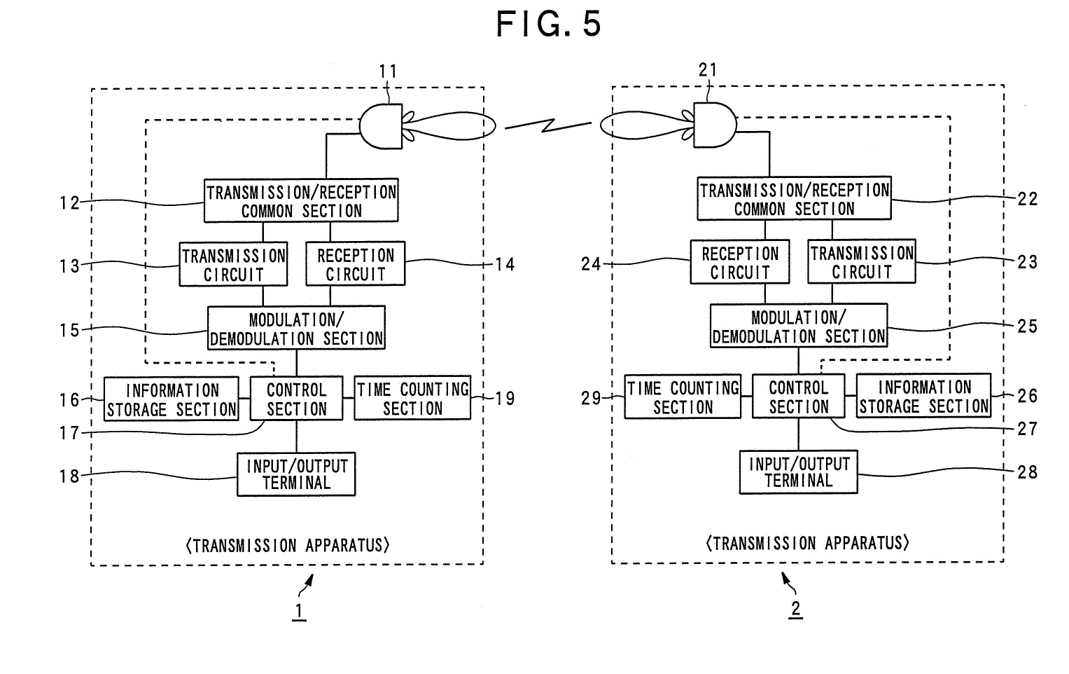

FIG. 5 is a diagram illustrating a constitutional outline of the communication system according to the second embodiment. Portions common with FIG. 2 are denoted by the same reference numerals, and the description thereof is omitted. A difference from the first embodiment is that the control sections 17 and 27 of the transmission apparatus 1 and the reception apparatus 2 have time counting sections 19 and 29 as one example of time counting devices, respectively.

The time counting sections 19 and 29 have a function for informing the control sections 17 and 27 of acquisition time when the communication conditions are acquired. In addition to the case of the first embodiment, the communication condition acquisition time is recorded in the communication history to be stored in the information storage sections 16 and 26.

In the second embodiment, a difference from the first embodiment is that in addition to the communication condition parameters in the first embodiment, a movement vector and movement vector calculated time are included in the communication condition parameters of the communication history to be stored in the information storage sections 16 and 26. The movement vector is described later.

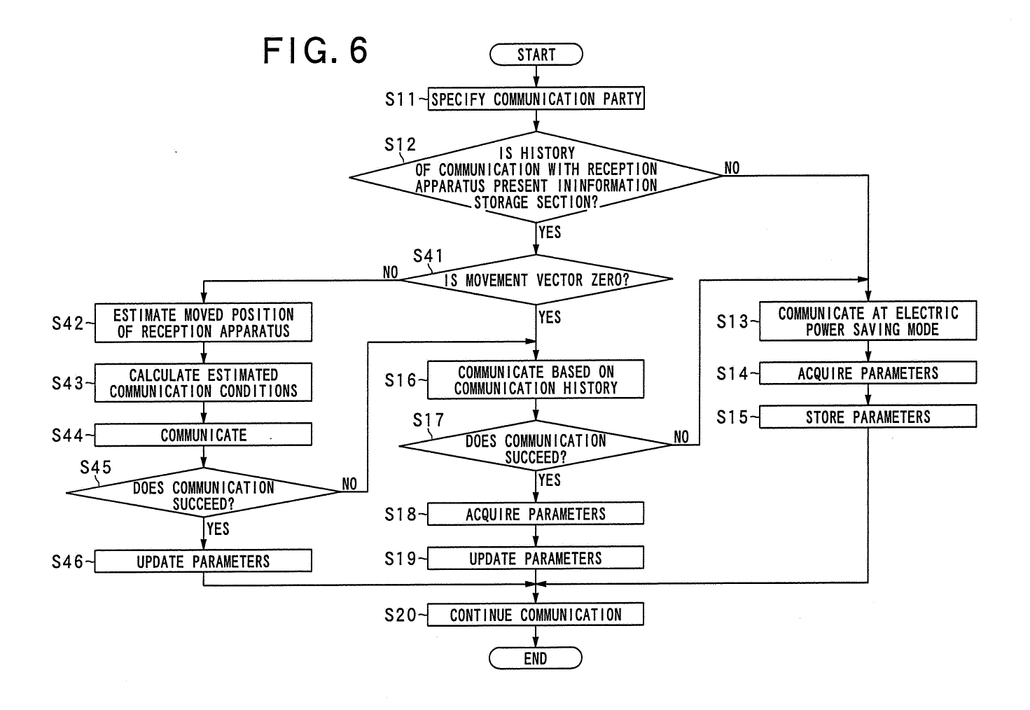

A communicating operation in the communication system according to the second embodiment of the present application having such a constitution is described below with reference to FIG. 6.

FIG. 6 is a flowchart when the communication is viewed from the side of the transmission/reception apparatus serving as the transmission apparatus 1 according to the second embodiment of the present application, and corresponds to FIG. 3 explaining the first embodiment. Portions common with FIG. 3 are denoted by the same reference numerals, and the description thereof is omitted.

Similarly to the flowchart in FIG. 3, when the power of the transmission apparatus 1 is turned on, the information for specifying a destination device (reception apparatus 2) as a communication object is input and the start of the communication is instructed (S11), the control section 17 searches whether the history of the communication with the reception apparatus 2 is present in the information storage section 16 (S12).

When the history of the communication with the reception apparatus 2 is not present (N at S12), this means that the communication with the reception apparatus 2 has not been carried out, and thus the communication with the reception apparatus 2 is started at the low-directional pattern by the similar method to the conventional technique. The directional characteristic is improved after the communication is established, and the transmission power is reduced so that the system goes to the electric power saving mode (S13). After the communication is stable, the communication condition parameters at this time are acquired (S14) and are stored in the information storage section 16 together with acquisition time (S15) so that the communication continues (S20).

On the other hand, when the history of the communication with the reception apparatus 2 as the destination device is present in the information storage section 16 of the transmission apparatus 1 (Y at S12), a check is made using the movement vector of the communication condition parameters in the communication history whether a relative position of the transmission apparatus and the reception apparatus 2 changes (S41). The movement vector is described later.

When the movement vector of the communication condition parameters in the communication history is 0 and the determination is made that the relative position of the transmission apparatus 1 and the reception apparatus 2 does not change (Y at S41), similarly to the first embodiment, the communication is carried out based on the communication condition parameters in the communication history (S16). When the communication succeeds (Y at S17), the communication condition parameters are acquired (S18), and the communication history of the information storage section 16 of the transmission apparatus 1 is updated by the parameters and acquisition time (S19) so that the communication continues (S20).

When the communication based on the communication condition parameters in the communication history does not succeed (N at S17), this is similar to the case where the history of the communication with the reception apparatus 2 is not present in the communication history (N at S12). For this reason, the sequence goes to the processes after step S13, the communication with the reception apparatus 2 is started at the low-directional pattern (S13), and after the communication condition parameters are acquired (S14), the communication condition parameters and acquisition time are stored in the information storage section 16 of the transmission apparatus 1 (S15) so that the communication continues (S20).

On the contrary, when the movement vector is not 0 and the determination is made that the relative position of the transmission apparatus 1 and the reception apparatus 2 changes (N at S41), a moved position of the reception apparatus 2 is estimated based on the communication history stored in the information storage section 16 (S42). Details of the estimating method as well as the movement vector are described later.

Estimated communication condition parameters are calculated based on the estimated moved position of the reception apparatus 2 (S43), and the communication with the reception apparatus 2 is started based on the parameters (S44).

A determination is made whether the communication is enabled (S45), and when the communication succeeds (Y at S45), the communication history in the information storage section 16 is updated by the communication condition parameters (S46) so that the communication continues (S20).

On the contrary, when the communication based on the calculated estimated communication condition parameters does not succeed (Y at S45), the communication is started based on the communication condition parameters at the time when the movement vector is 0 (after S16).

When the communication does not yet succeed at this time (N at S17), the sequence goes to the processes after step S13.

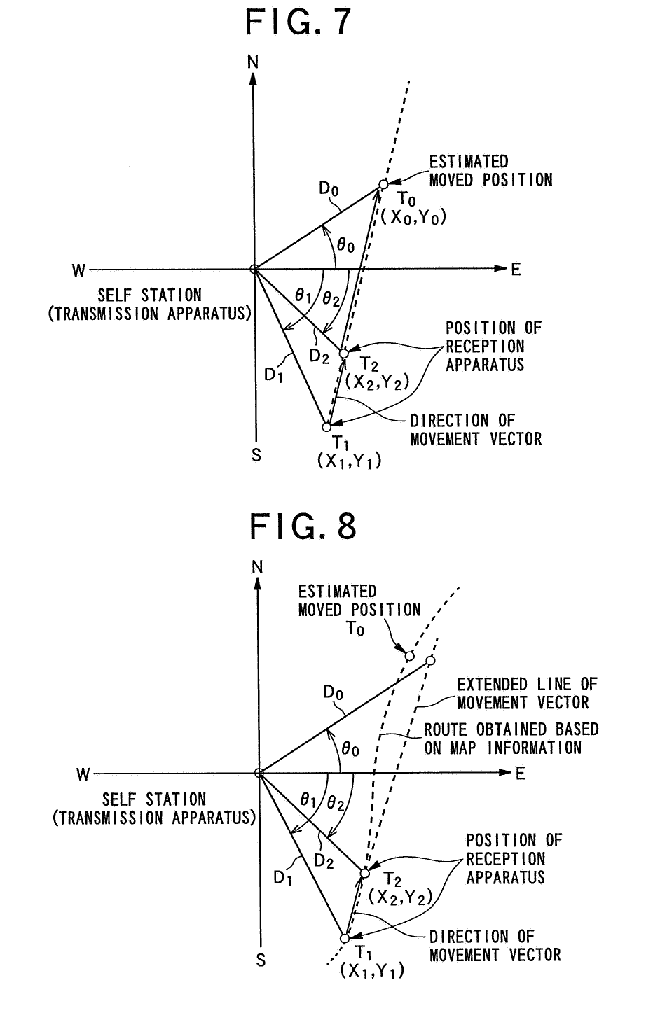

The processes (S42 and S43) for estimating the moved position of the destination device using the movement vector is described below. FIG. 7 is a diagram for explaining the process for estimating the moved position of the destination device using the movement vector.

A position X1, Y1 of the reception apparatus 2 can be specified based on a transmission direction θ1 in the communication condition parameters stored in the information storage section 16 and a distance D1 to the reception apparatus 2 calculated by a transmission output. According to the position X1, Y1 and acquisition time T1 at which the communication condition parameters are acquired, it is found that the reception apparatus 2 is present on the position X1, Y1 at time T1.

When the position of the reception apparatus at time T2 is X2, Y2, the movement vector at the time T2 can be calculated based on the information such that “the reception apparatus 2 is present on the position X1, Y1 at the time T1” according to the following formula:

X=(X₂−X₁)/(T₂−T₁),Y=(Y₂−Y₁)/(T₂−T₁) [Formula 1]

This movement vector means a speed of the reception apparatus 2 at the time T2. This movement vector and the movement vector calculated time T2 are stored in the communication history in the second embodiment.

The method of estimating the moved position of the reception apparatus using the movement vector is described below.

When current time is denoted by T0, an estimated moved position X0,Y0 of the reception apparatus 2 is expressed by the following formula after the elapsed time from the movement vector calculated time T2 is taken into consideration.

X₀=X×(T₀−T₂)+X₂,Y₀=Y×(T₀−T₂)+Y₂ [Formula 2]

Therefore, when the reception apparatus 2 is supposed to be moved to the estimated moved position X0,Y0 the communication parameters are set so that the communication can be restarted (S44).

In addition to the effect of the first embodiment, the second embodiment has the following effect.

The transmission apparatus 1 and the reception apparatus 2 have the antennas 11 and 21 which can control the directional characteristic, the information storage sections 16 and 26 which store the communication history including the communication conditions at the time of communication, and the control sections 17 and 27 which control the antennas 11 and 21 based on the stored communication history so that the communication with the destination device recorded in the communication history is enabled. For this reason, the antennas 11 and 21 are controlled with high-directional characteristic and weak transmission power based on the communication history so that the communication with a destination device can be restarted, thereby realizing lower power consumption and shortening of the time up to the establishment of the communication after the restart of the communication.

In the transmission apparatus 1 and the reception apparatus 2, the control sections 17 and 27 have the time counting sections 19 and 29, respectively. The control sections 17 and 27 calculate a movement vector of the destination device based on a past position and a current position of the destination device at the time of communication and elapsed time from the past communication time to the present time. The control sections 17 and 27 estimates a moved position of the destination device based on the movement vector, the movement vector calculated time and elapsed time from the movement vector calculated time to the present time so as to estimate communication conditions optimum for the communication and output them as estimated communication conditions. The control sections 17 and 27 control the antennas 11 and 21 based on the estimated communication conditions so as to enable the communication of the antenna 11 and 21, and restarts the communication. For this reason, the communication with the destination device in the estimated moved position can be restarted with high-directional characteristic and weak communication power, thereby realizing the low power consumption and the shortening of the time up to the establishment of the communication after the restart of the communication.

The estimated moved position of the reception apparatus 2 is calculated by using the movement vector, and the estimated communication condition parameters are calculated based on the estimated moved position so that the communication is restarted. For this reason, even in the state that the reception apparatus 2 moves, the communication can be restarted quickly.

In the second embodiment, the processes at steps S42 and S43 are executed by the control sections 17 and 27, so that an “estimating device” of claims is realized.

The embodiment of the present application is not limited to the above embodiments, and the embodiment may be modified in the following manner.

In a constitution which has a map information storage section as one example of a map information storage device on the side of the transmission apparatus 1, when it is found based on the position of the reception apparatus 2 that the reception apparatus 2 is moving on a road or a railway track, an estimated moved position may be calculated considering that the reception apparatus 2 is supposed to move along a predetermined route. That is to say, in the second embodiment, the moved position of the reception apparatus 2 is estimated under the condition that it moves on a straight line, but as shown in FIG. 8, when it is known beforehand based on the map information stored in the map information storage section that the rout is curved, a moved distance can be calculated based on a level (speed) of the movement vector and the elapsed time, and the moved position can be estimated based on the moved distance and the route information in the map information. As a result, even if the route is curved, the reception apparatus 2 in the estimated moved position obtained based on the map information is controlled so as to have high-directional characteristic and weak communication power so that the communication can be restarted. As a result, the low power consumption and the shortening of the time up to the establishment of the communication after the restart of the communication can be realized.

When the communication is restarted after the time elapses from the previous storage (update) of the communication history by not less than predetermined time, a position of the reception apparatus is not estimated by using the movement vector, an operation is performed considering that the communication history is not present. This is because when not less than the predetermined time elapses, it is assumed that the accuracy of the estimated moved position is deteriorated.

A program corresponding to the flow chart shown in FIG. 6 is recorded in an information recording medium such as a flexible disc or a hard disc, or the program is delivered and recorded via a network such as an internet, and the program is read and executed by universal microcomputers provided to the control section 17 of the transmission/reception apparatus serving as the transmission apparatus 1 and the control section 27 of the transmission/reception apparatus serving as the reception apparatus 2, so that the microcomputers can serve as the control sections 17 and 27.

The present invention is not limited to the above embodiments. The above embodiments are examples, and any techniques which have the substantially same constitution as technical idea described in claims of the present invention and produce the same effect are included in a technical scope of the present invention.

The present application claims priority to Japanese Patent Application (No. 2005-88946) including the specification, claims, drawings and abstract filed on Mar. 25, 2005, the entire disclosures of which are hereby incorporated by reference.

1-10. (canceled)

11. A directional communication apparatus, characterized by comprising:
a directional antenna capable of controlling a directional characteristic;
a storage device which stores communication history including at least a direction and a transmission power of a destination device at the time of communication, and directional parameters for specifying the directional characteristic as communication conditions at the time of communication; and
a control device which controls the directional antenna based on the stored communication history so that the antenna can communicate with the destination device recorded in the communication history.

12. The directional communication apparatus according to claim 11,
characterized in that the control device controls the directional antenna based on the communication history so as to restart the communication with the destination device.

13. The directional communication apparatus according to claim 11, characterized in that
the control device has a time counter,
the control device calculates a movement vector of the destination device based on a past position and a current position of the destination device at the time of communication, and elapsed time from the past communication time up to current time,
the communication history includes the movement vector and movement vector calculated time.

14. The directional communication apparatus according to claim 13, characterized by further comprising:
an estimating device which estimates a moved position of the destination device based on the movement vector and the movement vector calculated time in the communication history, and elapsed time from the movement vector calculated time to the current time, and estimates communication conditions optimum for communication so as to output the communication conditions as estimated communication conditions,
wherein the control device controls the directional antenna based on the estimated communication conditions so that the directional antenna can communicate with the destination device so as to restart the communication.

15. The directional communication apparatus according to claim 14, characterized by further comprising:
a map information storage device which stores map information,
wherein the estimating device estimates a moved position of the destination device based on the map information.

16. A communication method of a communication apparatus having a directional antenna capable of controlling a directional characteristic, characterized by comprising:
a process of storing communication history at least including a direction and a transmission power of a destination device at the time of communication and directional parameters for specifying the directional characteristic as communication conditions at the time of communication; and
a process of controlling the directional antenna based on the stored communication history so that the directional antenna can communicate with the destination device recorded in the communication history.

17. A recording medium where a communication program is recorded so as to be readable by a computer,
the communication program allowing the computer included in a communication apparatus having a directional antenna capable of controlling a directional characteristic to operate as:
a storage device which stores communication history including at least a direction and a transmission power of a destination device at the time of communication, and directional parameters for specifying a directional characteristic as communication conditions at the time of communication; and
a control device which controls the directional antenna based on the stored communication history so that the directional antenna can communicate with the destination device recorded in the communication history.

18. A communication system, using the directional communication apparatus according to claim 11,
characterized in that communication is carried out with any one of the directional communication apparatuses being used as a transmission apparatus and the other one being used as a reception apparatus.

19. A communication system, characterized by comprising:
the directional communication apparatus according to claim 11; and
a plurality of base stations which communicate with the directional communication apparatus.
